(19) United States
(12) Patent Application Publication
(10) Pub. No.: US 2006/0055541 A1
(43) Pub. Date: Mar. 16, 2006

(54) RFID tag having a silicon micro processing chip for radio frequency identification and a method of making the same

(76) Inventor: Frederick Bleckmann, Dover, NH (US)

Correspondence Address: NIXON PEABODY, LLP, 401 9TH STREET, NW, SUITE 900, WASHINGTON, DC, 20004-2128, US

(21) Appl. No.: 11/207,201

(22) Filed: Aug. 19, 2005

Related U.S. Application Data
(60) Provisional application No. 60/602,973, filed on Aug. 19, 2004.

(51) Int. Cl. G08B 13/14; G06K 19/06; H01Q 21/00

(52) U.S. Cl. 340/572.7; 343/893; 235/492

(57) ABSTRACT

A RFID device includes a silicon micro processing chip having an IC antenna disposed on a substrate or other surface, such as a label, tag or coin. At least one secondary antenna is also positioned on the substrate. The IC antenna of the chip is positioned within a coupling distance of the at least one secondary antenna in an insulated manner to form a RF inlet. When the RF inlet is placed in proximity to a transmitting and receiving antenna of a RFID system, the transmitting and receiving antenna transmits an output signal to the secondary antenna, and the secondary antenna in turn transmits the output signal to the IC antenna to provide an electromagnetic connection therebetween. The signals of IC antenna and secondary antenna are tuned to emit a uniform return signal that is received by the antenna of the RFID system to transfer data from the chip hereto.

### RELATED APPLICATIONS

This application claims priority of U.S. Provisional Application Ser. No. 06/602,973 filed Aug. 19, 2004. This application is also related to co-pending U.S. Patent Application Ser. No. 10/329,778 entitled “Method for Identifying Apparel Items.”

### BACKGROUND OF THE INVENTION

1. Field of the Invention

The present invention relates to a RFID device having a silicon micro processing chip for radio frequency identification, and more particularly, to a silicon chip having a first antenna built into the silicon chip and positioned in an insulated manner within coupling distance of a secondary antenna.

2. Description of the Related Art

The attachment of labels to cloth goods such as clothing, linens and towels is a common practice used to set forth information such as trademarks and trade names, material identification and characteristics, sizes, care instructions, and so forth. It addition, legal requirements necessitate the use of labels in clothing or on linens. A method and apparatus for producing individual folded labels from a ribbon of labels is presented in published PCT application WO 00/50239 and is incorporated in its entirety herein.

U.S. Pat. No. 6,827,817, incorporated in its entirety herein, discloses a folded label having radio frequency identification device (RFID) disposed therein. RFID tags typically consist of an antenna or a coil, to collect RF energy, and an integrated circuit (IC) which contains identification code or other information in its on-chip memory. The RFID device stores and transmits identifying information, such as inventory control, pricing control and the tracking of the origin of the merchandise.

The RFID device can be embedded into a plurality of objects, i.e., a product, person or animal, which allows the object to be tracked. Conventional RFID tags are semiconductor devices comprising an IC chip mounted on a substrate. Typically, the tags require an antenna to be formed on a substrate and a RF transceiver and memory circuit built in an integrated circuit (IC) chip form is in turn bonded to the substrate. RFID tags can be very small, i.e., smaller than a grain of rice, or as large as a book.

The antenna used in the RFID tag is a conductive element that allows the tag to exchange data with a reader. A passive RFID tag is one that requires no internal power source. In a passive RFID tag a coiled antenna can create a magnetic field using the energy provided by the reader's carrier signal. Due to the lack onboard power supply, the passive RFID tag can be very small and typically can only transmit a brief response, such as an ID number. On the other hand, active RFID tags have an internal power source and the ability to receive and store information sent by a transceiver.

Connection between the IC chip and antenna is provided by wire bonded connection pads. See U.S. Pat. No. 6,891,110. One disadvantage is that the wire bond between the IC chip and antenna is fragile and can chip or break due to external forces or the difference in coefficients of expansion between the IC chip and the substrate. Moreover, the manufacturing process to make the wire bonds is costly and tie consuming.

As disclosed in U.S. Pat. No. 6,344,824, it is also known to provide an IC chip wherein a radio-communicating antenna is used to receive and transmit signals thereto in a non-contact fashion. However, the circuit for surfaces of such non-contact devices are complex and cannot transmit signals over larger distances.

Flip Chip technology is another connection process used in place of wire bonding. In Flip chip processes precise gold solder points are placed on the chip and it is flipped onto the bond points. One disadvantage with this process is the large potential for waste, especially with smaller chips.

It would be desirable to be able to produce a RFID device that reduces all the difficulties of making a physical connection between the silicon micro processing chip and the antenna, with less waste, without the need for precise attachment and lower production costs.

It is also desirable to have a label that enables tracking of inventory, pricing and place of origin, without necessitating human intervention to research such information. The programmable and read-only scannable circuit boards cannot be altered or read without a programmer or reader. The RFID system typically consists of one or more transceivers (exciters) and one or more tags. An RFID tag generally incorporates a specific and unique identification number, where the number may be read by a RF transceiver (transmitter/receiver) system. The RFID tags may acquire energy from the incident radio frequency field or powered by battery

Attaching a RFID tag to a label enables the item to be located and identified with the aid of an RF interrogation system. As such, an interrogation system is able to identify information associated with the RFID labels as set forth in the present invention.

Commercially available RFID tags generally operate at low frequencies, typically below 1 MHz. Many 13.56 and 915 MHz tags are in the market today. Although lower frequency devices are more common, a wide range of high frequencies are available, for example, 13.56 MHz, 915 MHz, 2.45 GHz and 5.6 GHz. Low frequency tags usually employ a multi-turn coil resulting in a tag having a thickness much greater than a standard sheet of paper. 2.45 GHz and 5.6 GHz can be done in a single turn or as a die pole antenna. High frequency passive RFID tags, which orate at around 2.54 GHz, typically consist of a single turn, flat antenna, printed onto a flat single layer sheet of plastic or paper.

The combination of the folded labels with a RFID device of the present invention allows for locating and tracking of items, detecting items and reporting of pricing, for example. This ability to read RF labels from codes may be utilized, for example, as the items having the RF labels leave predetermined areas and pass through an exit.

Further, a label can be provided with a secondary or coupling antenna and an RFID tag can be placed within that antenna, effectively boosting the signal of the RFID tag to reach greater distances.

### SUMMARY OF THE INVENTION

An object of the present invention is to provide a RFID device that incorporates dual, coupled antennas

Another object of the present invention is to provide a RFID device that removes the need for a physical interconnect between the silicon chip antenna and other antennas.

Yet another object of the present invention is to provide a RFID device having a longer read distance then that which can be obtained by using only a silicon chip antenna.

Still another object of the present invention is to provide a method of making a RFID device, wherein a dual antenna configuration receives and returns a signal from a RFID scanner or other device.

Another object of the present invention is to provide a RFID device that can be incorporated into labels whereby inventory control, pricing control and the tracking of the origin of the merchandise, for example, can be done via the REID devices in the labels.

In accomplishing these and other objects of the present invention, there is provided a RFID device comprising a silicon micro processing chip having a first antenna disposed on a substrate. At least one secondary antenna is also disposed on the substrate. The first antenna is disposed within a coupling distance of the at least one secondary antenna in an insulated manner to form a RF inlet. When the RF inlet is placed in proximity to a transmitting antenna of a RFID system the transmitting antenna communicates with at least one secondary antenna, and the at least one secondary antenna is coupled to the first antenna to provide a connection therebetween.

In accomplishing these and other objects of the present invention there is also provided a method of forming a RFID device, comprising the steps of providing a silicon micro processing chip, the silicon chip having a first antenna built therein. The silicon micro processing strip is positioned on a substrate. At least one secondary antenna is also disposed on the substrate within coupling distance of the first antenna to form a RF inlet, the first and at least one secondary antennas being insulated from each other. A RFID system is provided. The RFID system includes a transmitting and receiving antenna. When the RF inlet is placed in the proximity of the RFID system and an output signal is transmitted from the transmitting antenna the at least one secondary antenna receives the output signal and couples with the first antenna to provide a return signal that is received by the transmitting and receiver antenna of the REID system to transfer data from the silicon micro processing chip to the RFID system.

It should be appreciated that the term substrate is considered to incorporate any circuit forming surface, including glass, plastic, a silicon wafer, coin, card or RFID tag. Moreover, the substrate can be made of numerous materials as in known in the art. For example, plastic, glass or silicon surfaces can be used. Additionally, any such surface could be coated with a layer of appropriate material as is also known in the art.

The silicon micro processing chip can be made using known fabricating methods, such as semiconductor processing machines. Furthermore, it should be appreciated that the chip and antennas can be bonded or otherwise physically attached to the substrate or supporting surface in known manners.

These and other objects, features, aspects, and advantages of the present invention will become more apparent from the following detailed description of the preferred embodiment relative to the accompanied drawings, in which:

### BRIEF DESCRIPTION OF THE DRAWINGS

FIG. 1 is a top plan view of the RFID device of the present invention.

FIG. 2 depicts the RFID device of FIG. 1 wherein the transmitting antenna of the RFID system is transmitting an output signal.

FIG. 3 depicts the REID device of FIG. 1 wherein the secondary antenna is transmitting the output signal to the IC antenna.

FIG. 4 is depicts the RFID device of FIG. 1 wherein the IC antenna and secondary antenna are transmitting a coupled return signal to the RFID system.

FIG. 5 illustrates a label having a RFID device of the present invention incorporated therein with an edge of the label pulled away.

### DETAILED DESCRIPTION OF PREFERRED EMBODIMENTS

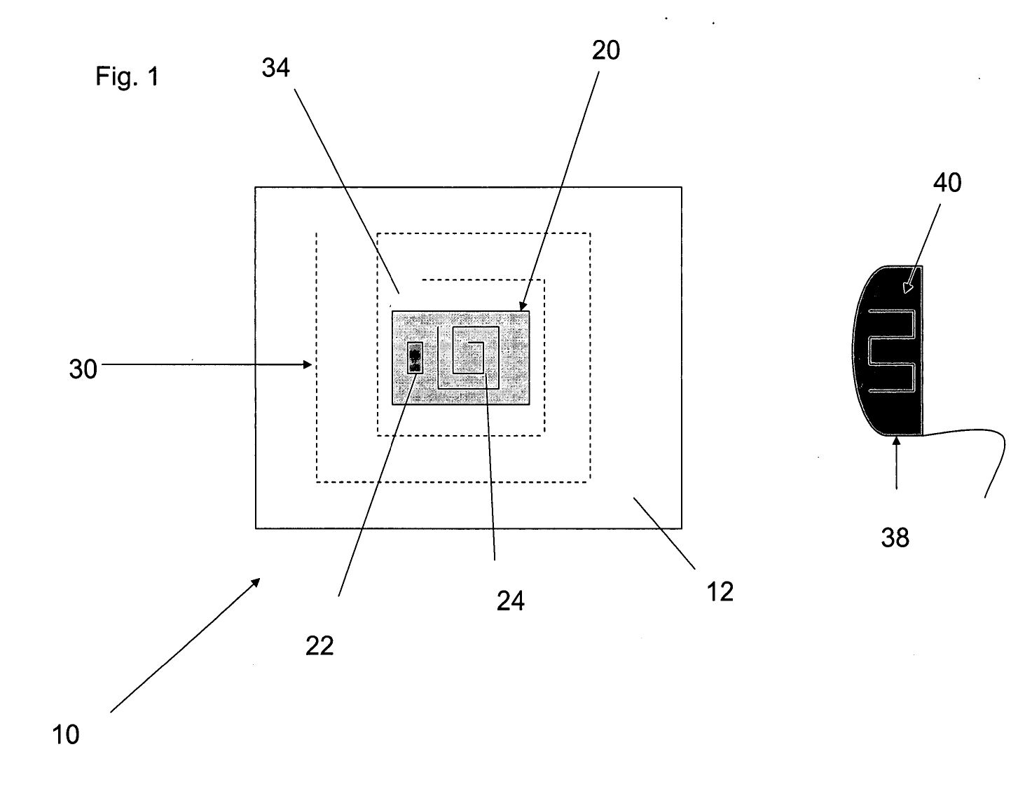

A RFID device 10 according to the present invention is shown in FIG. 1. Device 10 can be a radio frequency inventory/antitheft control device, or other equivalent device. A silicon micro processing chip 20 contains base RFID circuitry 22 and a first or basic IC, silicon chip antenna 24 built into the silicon. Chip 20 can be disposed on a substrate 12 in a manner known in the art. As previously mentioned, substrate 12 can be a tag, label, silicon wafer, plastic, glass, coin, card or other known material.

A secondary or intermediate antenna 30 shown by dashed line is disposed on the substrate. Although a single secondary antenna is shown, it should be appreciated that more than one secondary, coupling antenna could be used in the device. Attachment of the secondary antenna can be done by several ways, for example, applied by adhesive or sticker, heat set, woven into fabric, part of a laminate, part of a web, loose or press fit, or attached by other known means to the substrate. In a similar manner, the IC antenna and chip can be glued, laminated, press fit, etc.

As shown in FIGS. 1-5, chip 20 is placed within intermediate antenna 30 to form a RF inlet 32. The chip 20 is placed within coupling distance to coupling antenna 30. Although it is shown that chip 20 is located within antenna 30, other positional relationships between the two antennas are contemplated by the present invention. For example, chip 20 and IC antenna 24 can be located above, below or next to the secondary antenna.

Coupling distance is defined as the distance necessary for radio communication between IC antenna 24 and coupling antenna 30. With regard to the coupling between the secondary antenna and the RFID system/reader, the coupling distance is the distance the two antennas will couple at. With limited power or antenna size this coupling distance may be rather short—with more power and/or a larger antenna, the coupling will Occur over a larger distance, so coupling distance is a function of power and antenna size (and/or resistance)

No connecting pads or other contact means are necessary to form an electrical or electromagnetic connection between the IC antenna 24 and intermediate antenna 30. Thus, the two antennas are physically insulated from one another.

Intermediate antenna 30 is tuned to couple with both IC antenna 24 and transmitting antenna 40. Both IC antenna 24 and intermediate antenna 30 have the same radio frequency. As will be explained further herein, the two antenna couple together to provide a single response. This coupling removes the need for a physical contact between the IC antenna and intermediate antenna.

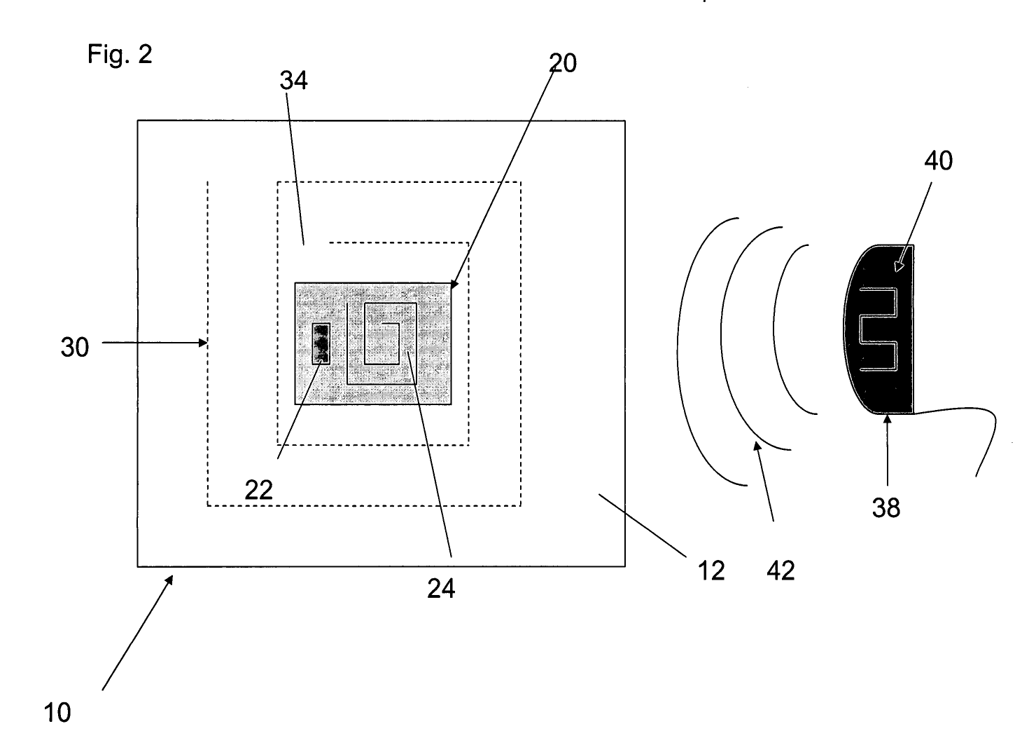

Referring to FIG. 2, the transmitting antenna shown generally at 40 provides an output signal 42. Transmitting antenna 40 can be included in an RFID system 38. As is known in the art, RFID system 38 also may include a reader/writer or scanner, not shown, or other equivalent device. When inlet 34 is placed within proximity of RFID system 38, output signal 42 is generated

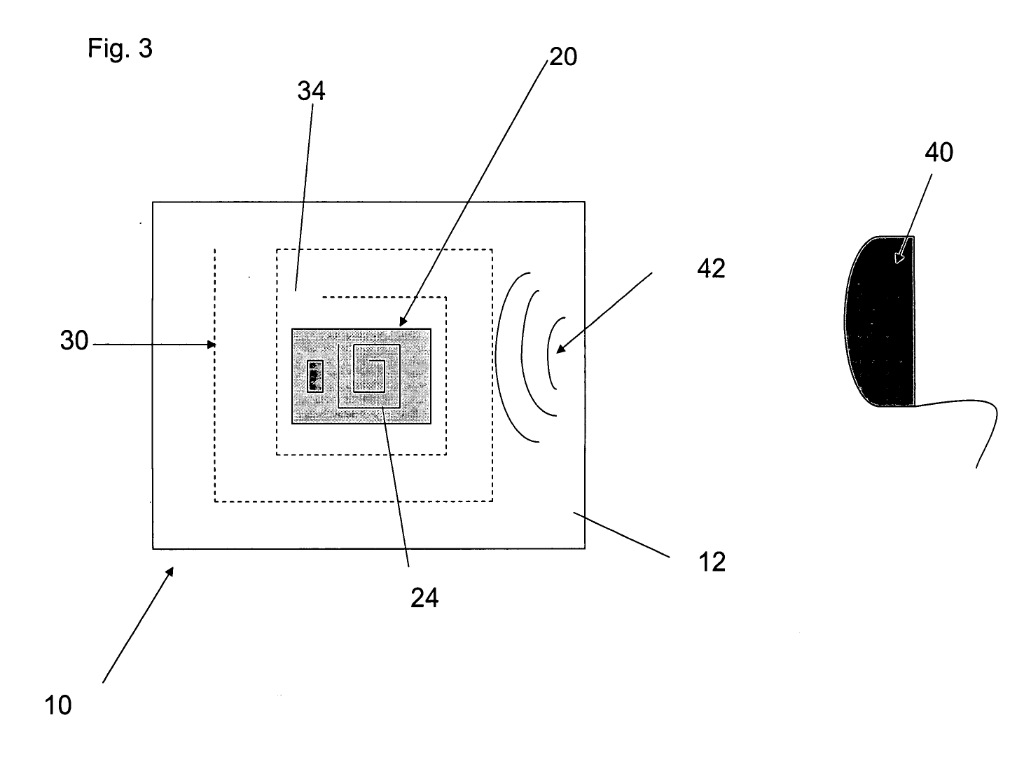

As shown in FIG. 3, transmitting antenna 38 provides output signal 42. By introducing a radio frequency signal (42) the dual antenna configuration of antennas 24, 30 are signaled. Intermediate antenna 30, the larger antenna of the two, on the inlet 34 is excited by the signal field.

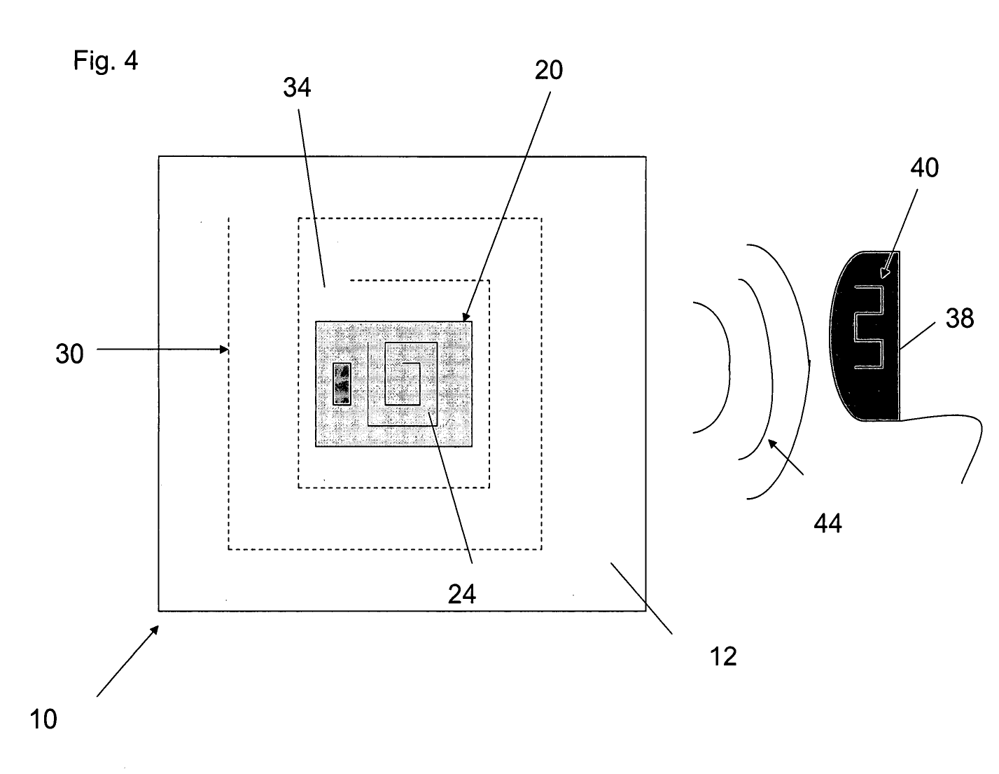

Referring to FIG. 4, intermediate antenna 30 than couples with IC antenna 24 of chip 12 to provide a uniform return signal 44 which is received by the radio frequency field generator of RFID system 38 via antenna 40 to transfer the data. The signal travels between the tree antennas, the reader antenna 40 to the secondary 30 to the IC antenna 24, and then back. Coupling will only occur between two antennas at the same time. Intermediate antenna 30 provides a longer read distance than that which could be obtained by using only IC antenna 24.

In operation, the RFID device of the present invention is made according to the steps of providing a silicon micro processing chip having an IC antenna built therein, along with base RFID circuitry. At least one secondary antenna is positioned on a surface, such as previously described herein. The micro processing strip is positioned within the secondary antenna so that the IC antenna is within a coupling distance of the secondary antenna in a physically insulated manner to form a RF inlet.

The RFID system includes the transmitting and receiving antenna that transmits an output signal when the RF inlet is positioned within the proximity of the transmitting and receiving antenna. The transmitting and receiving antenna transmits the output signal such that the secondary antenna receives the output signal and couples with the first antenna. Both the IC and secondary antenna have radio frequency outputs that can be tuned or coupled to emit a uniform signal as described herein. The signals of the IC and secondary antenna provide a uniform return signal that is received by the transmitting and receiver antenna of the RFID system to transfer data from the silicon micro processing chip to the RFID system.

The present invention is particularly suited for insertion of devices such as security and inventory control devices, e.g., radio frequency inventory devices (RED) tags, into labels. The scannable circuit board chip 20 allows a RF label to be read or written to. The ability to write to the RF labels enables users to keep and update a database without the end user being able to alter the information on the embedded circuit board. In addition, the identification information may be reused and written over.

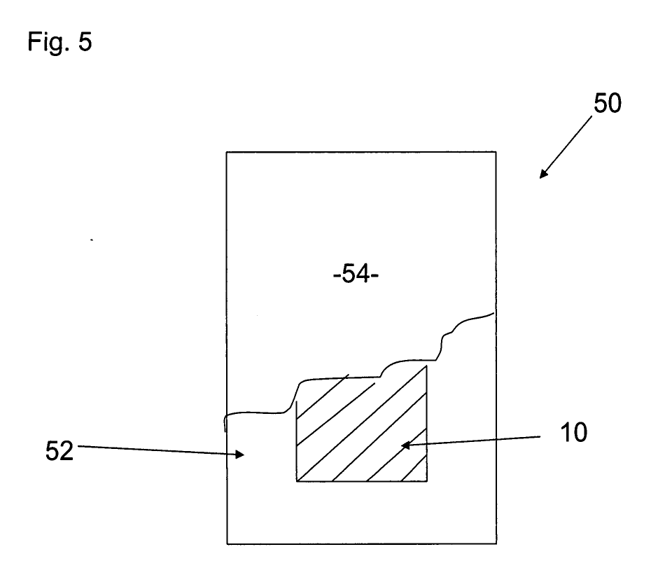

Look-up databases can be readily available to facilitate quick access to the information embedded on the RF labels. Moreover, lost or stolen items having the RF labels can be reunited with its owner or place of origin. Such a center fold label is illustrated in FIG. 5. Label 50 with the REID device 10 is disposed between the back 52 and front 54 the label. A portion of the material of 54 is pulled back to show device 10 and a portion of the back 52 to which it is mounted.

Although the present invention has been described in relation to particular embodiments thereof, many other variations and modifications and other uses will become apparent to those skilled in the art. It is preferred therefore, that the present invention be limited not by the specific disclosure herein, but only by the appended clans.

What is claimed is:

1. A RFID device comprising:
a silicon micro processing chip having a first antenna disposed on a substrate; and
at least one secondary antenna disposed on said substrate, said first antenna being disposed within coupling distance of said at least one secondary antenna in an insulated manner to form a RF inlet, wherein when said RF inlet is placed in proximity to a transmitting and receiving antenna of a RFID system said transmitting and receiving antenna transmits an output signal to said at least one secondary antenna, and said at least one secondary antenna transmits said output signal to said first antenna to provide an electromagnetic connection therebetween.

2. The RFID device of claim 1, wherein said micro processing chip includes RFID circuitry and said first antenna.

3. The RFID device of claim 1, wherein said silicon micro processing chip is disposed within said at least one secondary antenna.

4. The RFID device of claim 1, fiber comprising a plurality of secondary antenna.

5. The RFID device of claim 1, wherein said first antenna and said at least one secondary antenna have the same radio frequency.

6. The RFID device of claim 5, wherein said first and said at least one secondary antenna are coupled to transmit a uniform return signal, wherein said return signal is received by said transmitting and receiving antenna to transfer information between said micro processing chip and said RFID system.

7. The RFID device of claim 6, wherein said first antenna and said at least one second antenna are physically insulated from each other.

8. The RFID device of claim 7, wherein the coupling distance is a distance sufficient to provide the physical insulation between said first and said at least one secondary antenna, but still enable said first and said at least one secondary antenna to couple to transmit said return signal.

9. A RFID device comprising:
a silicon micro processing chip having a first antenna;
at least one secondary antenna disposed within a coupling distance of said first antenna in an insulated manner; and
a transmitting and receiving antenna that transmits an output signal to said at least one secondary antenna, and said at least one secondary antenna transmits said output signal to said first antenna to provide a connection therebetween.

10. The RFID device of claim 9, wherein said micro processing chip includes RFID circuitry and said first antenna.

11. The RFID device of claim 9, wherein said silicon micro processing chip is disposed within said at least one secondary antenna.

12. The RFID device of claim 9, further comprising a plurality of secondary antenna.

13. The RFID device of claim 9, wherein said first antenna and said at least one secondary antenna have the same radio frequency.

14. The RFID device of claim 13, wherein said first and said at least one secondary antenna are coupled to transmit a uniform return signal.

15. The RFID device of claim 14, wherein said transmitting and receiving antenna is disposed in a RFID system located at a location remote from said silicon micro processing chip, said return signal being received by said transmitting and receiving antenna to transfer information between said micro processing chip and said RFID system.

16. The RFID device of claim 15, wherein said first antenna and said at least one second antenna are physically insulated from each other.

17. The RFID device of claim 16, wherein the coupling distance is a distance sufficient to provide the physical insulation between said first and said at least one secondary antenna, but still enable said first and said at least one secondary antenna to couple to transmit said return signal.

18. The RFID device of claim 9, wherein the silicon micro processing chip is disposed on a RFID tag.

19. The RFID tag of claim 18, wherein said at least one secondary antenna is disposed on a label.

20. A method of forming a RFID device, comprising the steps of:
providing a silicon micro processing chip, said silicon chip having a first antenna;
positioning at least one secondary antenna on a substrate;
positioning said silicon micro processing strip on said substrate such that said first antenna is within a coupling distance of said at least one secondary antenna to form an RF inlet, said first and secondary antennas being insulated from each other,
providing a RFID system, said RFID system including a transmitting and receiving antenna;
positioning said RF inlet of said chip in the proximity of said RFID system; and
transmitting an output signal from said transmitting and receiving antenna such that said at least one secondary antenna receives the output signal and couples with the first antenna to provide a return signal that is received by the transmitting and receiver antenna of said RFID system to transfer data from the silicon micro processing chip to the RFID scanner.

21. The method of claim 20, wherein the step of positioning said micro processor strip comprises physically isolating said first antenna from said at least one secondary antenna.

22. The method of claim 20, wherein the step of positioning said at least one secondary antenna comprises positioning a plurality of secondary antenna on said substrate.

23. The method of claim 20, further comprising the step of tuning the radio frequencies of the first antenna and at least one secondary antenna to couple the antennas together to transmit a uniform return signal.

24. The method of claim 20, further comprising the step of positioning a RFID device within a label.
